(19) United States
(12) Patent Application Publication
(10) Pub. No.: US 2008/0289699 A1
(43) Pub. Date: Nov. 27, 2008

(54) Downspout framing systems and methods

(76) Inventor: Gerard Buonpane, Monroe Township, NJ (US)

Correspondence Address: Gerard Buonpane, 5 Regal Court, Monroe Township, NJ, 08831-5963, US

(21) Appl. No.: 11/805,210

(22) Filed: May 22, 2007

(51) Int. Cl. F16L 57/00

(52) U.S. Cl. 137/363

(57) ABSTRACT

A downspout skirt includes a first skirt member having first and second exposed ends and having an inner surface configured to engage a side wall of a downspout, and including a second skirt member having third and fourth exposed ends and having an inner surface configured to engage a different side wall of the downspout. The downspout skirt also includes a fastening system for removably coupling the first and second exposed ends of the first skirt member to the third and fourth exposed ends of the second skirt member.

### BACKGROUND OF THE INVENTION

This invention relates generally to downspout framing systems and methods, and more specifically, to a downspout skirt for framing a downspout along a decking surface.

Buildings are typically provided with downspouts for draining water collected in roof gutters. The downspouts typically run vertically along an exterior surface of the building to the ground, where the water is dissipated. Buildings also typically include a deck defined generally as a constructed flat surface capable of supporting weight, similar to a floor but typically constructed outdoors and usually connected to a building. The deck includes the deck flooring and the deck railings, both of which may be joined to or positioned adjacent to the exterior wall of the building. Typically, consideration is given to the placement of either the deck or the downspouts such that the two elements are not positioned at the same location of the building. However, in some situations, the downspouts and the deck must be positioned at the same location of the building. In such a situation, the downspout passes through an opening or cutout made in the decking surface (e.g. the deck flooring).

However, problems exist with these known construction and installation techniques. For example, the placement of the opening may not be aligned with desired placement of the downspout, so that when the downspout is installed, the downspout does not align with the opening. Conventional solutions to this problem include widening the opening or shifting the downspout, which causes the downspout to be in a non-vertical orientation. Other problems with providing the downspout through the opening include free movement of the downspout within the opening. This movement may eventually lead to damage to the downspout or a decrease in the structural integrity between the downspout and the gutter. Moreover, the interface between the downspout and the decking surface is visually un-appealing to some customers.

A need exists for a component that provides structural integrity to the downspout, while providing a finished look to the interface between the decking surface and the downspout.

### BRIEF DESCRIPTION OF THE INVENTION

In one aspect, a downspout skirt is provided including a first skirt member having first and second exposed ends and having an inner surface configured to engage a side wall of a downspout. The downspout also includes a second skirt member having third and fourth exposed ends and having an inner surface configured to engage a different side wall of the downspout, whereby the first and second skirt members are removably coupled to the downspout.

In another aspect, a downspout framing system is provided for framing side walls of a downspout proximate a downspout portion extending through a decking surface. The system includes a first skirt member having first and second exposed ends, and having an inner surface configured to engage a side wall of the downspout. The first skirt member also includes a base configured to rest upon the decking surface proximate the downspout. The system also includes a second skirt member having third and fourth exposed ends, and having an inner surface configured to engage a different side wall of the downspout. The second skirt member also includes a base configured to rest upon the decking surface proximate the downspout. The first and second skirt members are removably coupled to the downspout.

In a further aspect, a downspout framing system is provided for framing side walls of a downspout proximate a downspout portion extending through a decking surface. The system includes a first skirt member having first and second exposed ends, and having an inner surface configured to engage a side wall of the downspout. The first skirt member also includes a base configured to rest upon the decking surface proximate the downspout. The system also includes a second skirt member having third and fourth exposed ends, and having an inner surface configured to engage a different side wall of the downspout. The second skirt member also includes a base configured to rest upon the decking surface proximate the downspout. The system further includes a fastening system for removably coupling the first and second exposed ends of the first skirt member to the third and fourth exposed ends of the second skirt member.

### BRIEF DESCRIPTION OF THE DRAWINGS

FIG. 1 illustrates a cross-sectional view of a downspout framing system for framing a downspout along a decking surface.

FIG. 2 illustrates a top view of a downspout framing system formed in accordance with an exemplary embodiment.

FIG. 3 illustrates a top view of an alternative fastening system for the downspout framing system illustrated in FIG. 1.

FIG. 4 illustrates a top view of an alternative downspout framing system formed in accordance with an alternative embodiment.

FIG. 5 illustrates a top view of an alternative downspout framing system formed in accordance with an alternative embodiment.

FIG. 6 illustrates a perspective view of another alternative downspout framing system formed in accordance with an alternative embodiment.

FIG. 7 illustrates a perspective view of yet another alternative downspout framing system formed in accordance with an alternative embodiment.

### DETAILED DESCRIPTION OF THE INVENTION

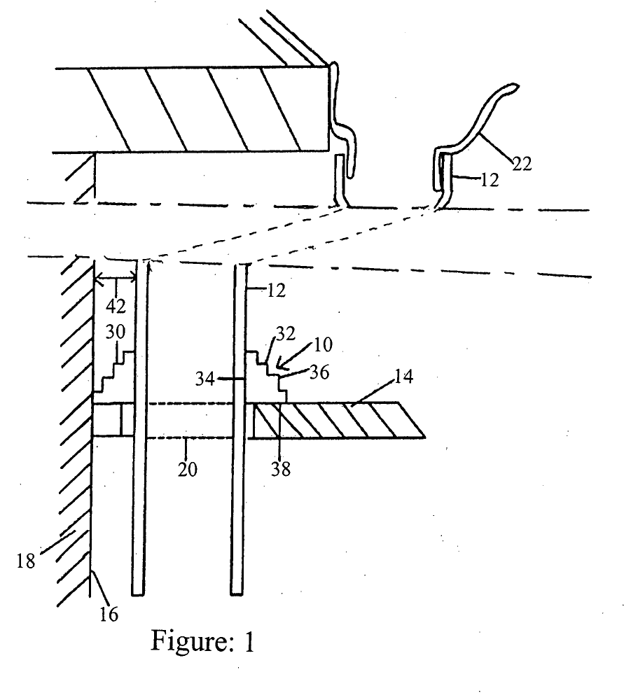

FIG. 1 illustrates a cross-sectional view of a downspout framing system 10 for framing a downspout 12 along a decking surface 14. In an exemplary embodiment, the decking surface 14 abuts against siding 16 of a building 18. The decking surface 14 may be secured to the building 18. The decking surface 14 may be any decking surface 14, such as a deck railing or a deck floor. The decking surface 14 may be fabricated from any known decking material, such as wood, vinyl, wood and plastic composite lumber, and the like. The decking surface 14 includes an opening 20 therethrough, and the downspout 12 is received in the opening 20. In an exemplary embodiment, the opening 20 is positioned adjacent the building 18 such that the downspout 12 may extend along the siding 16 from a gutter 22 to the ground. Optionally, the opening 20 may open to the siding 16 such that no decking surface 14 is between the downspout 12 and the siding 16. The downspout 12 may be fed through the opening 20 after the decking surface 14 is secured to the house 18. Alternatively, the decking surface 14 may be placed around the downspout 12 while the downspout 12 is attached to the building 18.

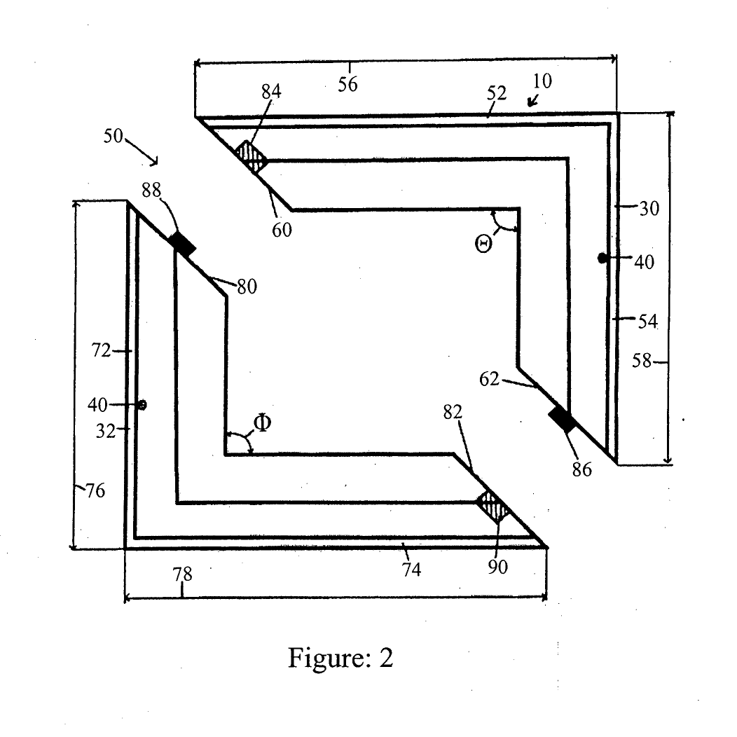

In an exemplary embodiment, the downspout framing system 10 is used to surround a perimeter of the downspout 12 at the interface of the downspout 12 and the decking surface 14. The downspout framing system 10 facilitates providing a finished look to the interface of the downspout 12 and the decking surface 14. The downspout framing system 10 includes at least two skirt members 30 and 32. Each of the skirt members includes an inner surface 34 and an outer surface 36. Optionally, the outer surface 36 may be beveled or cut in a decorative pattern to provide a finished look. The inner surface 34 engages the perimeter of the downspout 12. Optionally, the skirt members 30 and 32 hold the downspout 12 in a fixed position within the opening 20. As such, the downspout framing system 10 provides stability to the downspout 12. In an exemplary embodiment, each of the skirt members 30 and 32 include a base 38 extending substantially perpendicular to the inner surface 34. The base 38 rests upon the decking surface 14. In an exemplary embodiment, because the opening 20 may be larger than the downspout 12, a portion of the base 38 may overhang the opening 20. Optionally, the skirt members 30 and 32 may include fastener bores 40 (shown in FIG. 2) extending from the outer surface 36 to the base 38. The fastener bores 40 receive a fastener such as a screw or nail for securing the skirt member 30 or 32 to the decking surface 14. The fastener provides stability to the skirt members 30 and 32. In one embodiment, the downspout 12 is positioned a distance 42 from the siding 16 such that a gap is formed therebetween. One of the skirt members 30 is positioned within the gap.

FIG. 2 illustrates a top view of the downspout framing system 10 formed in accordance with an exemplary embodiment. The downspout framing system 10 includes the first skirt member 30 and the second skirt member 32. Each of the first and second skirt members 30 and 32 are L-shaped, and are coupled together using a fastening system 50. Once coupled together, the skirt members 30 and 32 form a hollow, rectangular box-shaped structure for surrounding the perimeter of the downspout 12 (shown in FIG. 1). In an exemplary embodiment, the skirt members 30 and 32 are vinyl. However, the skirt members 30 and 32 may be fabricated from other materials such as wood, plastic, metal, wood and plastic composite lumber, and the like.

The first skirt member 30 includes a first leg 52 and a second leg 54. The first leg 52 has a length 56 and the second leg 54 has a length 58. Optionally, the lengths 56 and 58 may be substantially equal. Alternatively, one of the lengths 56 or 58 may be longer than the other length 56 or 58. The legs 52 and 54 are coupled together using known manufacturing or assembly techniques. The legs 52 and 54 are fixedly coupled to one another at an angle Θ. Optionally, the angle Θ is approximately 90 degrees, such that the legs 52 and 54 are substantially perpendicular to one another. Alternatively, the legs 52 and 54 may be unitarily formed with one another from a single piece of material. The first leg 52 includes a first exposed end 60 opposite the portion of the first leg 52 that is joined to the second leg 54. Similarly, the second leg 54 includes a second exposed end 62 opposite the portion of the second leg 54 that is joined to the first leg 52. As such, the first skirt member 30 includes two exposed ends. The exposed ends 60 and 62 are arranged and configured to be joined to the second skirt member 32 using the fastening system 50.

The second skirt member 32 includes a third leg 72 and a fourth leg 74. The third leg 72 has a length 76 and the fourth leg 74 has a length 78. Optionally, the lengths 76 and 78 may be substantially equal. Alternatively, one of the lengths 76 or 78 may be longer than the other length 76 or 78. The legs 72 and 74 are coupled together using known manufacturing or assembly techniques. The legs 72 and 74 are fixedly coupled to one another at an angle Φ. Optionally, the angle Φ is approximately 90 degrees, such that the legs 72 and 74 are substantially perpendicular to one another. Alternatively, the legs 72 and 74 may be unitarily formed with one another from a single piece of material. The third leg 72 includes a third exposed end 80 opposite the portion of the third leg 72 that is joined to the fourth leg 74. Similarly, the fourth leg 74 includes a fourth exposed end 82 opposite the portion of the fourth leg 74 that is joined to the third leg 72. As such, the second skirt member 32 includes two exposed ends. The exposed ends 80 and 82 are arranged and configured to be joined to the first skirt member 30 using the fastening system 50.

The fastening system 50 includes a first fastening element 84, a second fastening element 86, a third fastening element 88, and a fourth fastening element 90. However, more or less fastening elements may be utilized in the fastening system 50. In the exemplary embodiment, the fastening elements 84, 86, 88 and 90 are coupled to the exposed ends 60, 62, 80 and 82, respectively. The first and third fastening elements 84 and 88 cooperate to couple the first and third legs 52 and 72 to one another. In the illustrated embodiment, the first fastening element 84 represents a female recessed cut-out along the first exposed end 60 and the third fastening element 88 represents a vinyl male extension protruding outward from the third exposed end 80. In the illustrated embodiment, the male extension 88 and the female recessed cut-out 84 are formed of the same material as the third leg 72 and the first leg 52 and may be molded or manufactured at the same time as legs 72 and 52. The third fastening element 88 is sized and shaped to substantially fill the cut-out 84. Optionally, the third fastening element 88 and the cut-out 84 may be rectangular. Alternatively, the third fastening element 88 and the cut-out 84 may be any other shape, such as square, circular, oval, triangular, or irregularly shaped. When placed together, the fastening elements 84 and 88 interact with one another to couple the first and third legs 52 and 72 to one another. In alternative embodiments, the first and third fastening elements 84 and 88 may be other types of fasteners, such as, but not limited to, hook and loop fasteners, a screw bore and a screw, a latch system, a hook and catch system, a buckle and strap system, a keyed jigsaw opening and receiving element, a rail or channel and receiving arm system, dowels or pins and corresponding openings, magnetic plates, and the like.

Similarly, the second and fourth fastening elements 86 and 90 cooperate to couple the second and fourth legs 54 and 74 to one another. In the illustrated embodiment, the fourth fastening element 90 represents a female recessed cut-out along the fourth exposed end 82 and the second fastening element 86 represents a vinyl male extension protruding outward from the second exposed end 62. In the illustrated embodiment, the male extension 86 and female recessed cut-out 90 are formed of the same material as the second leg 54 and the fourth leg 74 and may be molded or manufactured at the same time as legs 54 and 74. The second fastening element 86 is sized and shaped to substantially fill the cut-out 90. Optionally, the second fastening element 86 and the cut-out 90 may be rectangular. Alternatively, the second fastening element 86 and the cut-out 90 may be any other shape, such as square, circular, oval, triangular, or irregularly shaped. When placed together, the fastening elements 86 and 90 interact with one another to couple the second and fourth legs 54 and 74 to one another. In alternative embodiments, the second and fourth fastening elements 86 and 90 may be other types of fasteners, such as, but not limited to, hook and loop fasteners, a screw bore and a screw, a latch system, a hook and catch system, a buckle and strap system, a keyed jigsaw opening and receiving element, a channel and receiving arm system, dowels or pins and corresponding openings, magnetic plates, and the like.

During assembly, the first skirt member 30 is placed adjacent the downspout 12 along first and second side walls of the downspout 12. Optionally, the inner surface 34 of the first skirt member 30 may contact the side walls of the downspout 12. Alternatively, the inner surface 34 may be placed proximate the downspout 12. Once positioned, the second skirt member 32 is brought into a pre-mating position, such as the position illustrated in FIG. 2. In the pre-mating position, the third and fourth legs 72 and 74 of the second skirt member 32 are positioned along side of third and fourth side walls of the downspout 12. Additionally, the first and third exposed ends 60 and 80 and the second and fourth exposed ends 62 and 82 are substantially aligned with one another. The first and/or second skirt members 30 and/or 32 are moved toward one another to an assembled position, wherein the third fastening element 88 is received within the cut-out 84 and the first and third fastening elements 84 and 88 securely hold the first and third exposed ends 60 and 80 together. Similarly, in the assembled position, the second fastening element 86 is received within the cut-out 90 and the second and fourth fastening elements 86 and 90 securely hold the second and fourth exposed ends 62 and 82 together. Once assembled, the first and second skirt members 30 and 32 surround the perimeter of the downspout 12. Optionally, the inner surfaces 34 of the first and second skirt members 30 and 32 may engage the downspout 12. Alternatively, less than all of the inner surfaces 34 may engage the downspout 12.

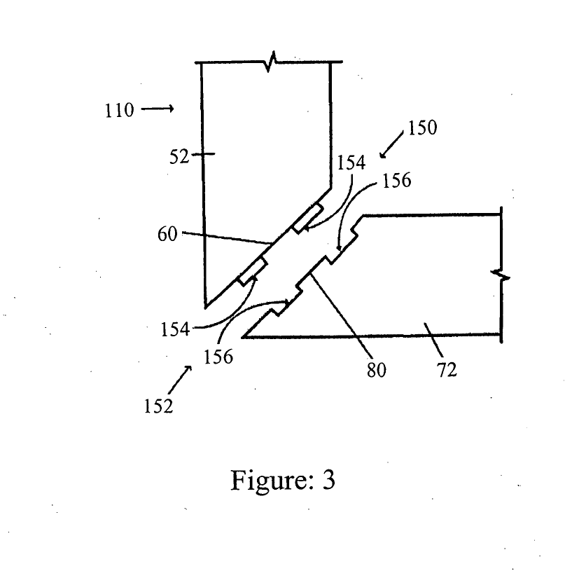

FIG. 3 illustrates a top view of an alternative fastening system 150 for the downspout framing system 110. The fastening system 150 includes multiple fastening elements 152 and is used to couple the first and third legs 52 and 72 together. Similar fastening elements may be used to couple the second and fourth legs 54 and 74 (shown in FIG. 2) to one another. In the illustrated embodiment, the first exposed end 60 includes two male extensions 154 extending outwardly therefrom. In the illustrated embodiment, the male extensions 154 are formed of the same material as the first leg 52 and may be molded or manufactured at the same time as the leg 52. Alternatively, the male extensions may be a separate component that is attached to the first leg 52 such as by an adhesive or other fastening device or system. The male extension may be made of the same type of material as the first leg 52 or may be made from a different material. The third exposed end 80 includes two cut-outs 156 extending inwardly therefrom. The cut-outs 156 are similarly sized and shaped as the corresponding male extensions 154 and snugly and securely receive the male extensions 154 for holding the first and third legs 52 and 72 together. Optionally, the cut-outs 156 may be differently shaped and sized. In other alternative embodiments, more than two fastening elements may be provided on each exposed end 60 and 80.

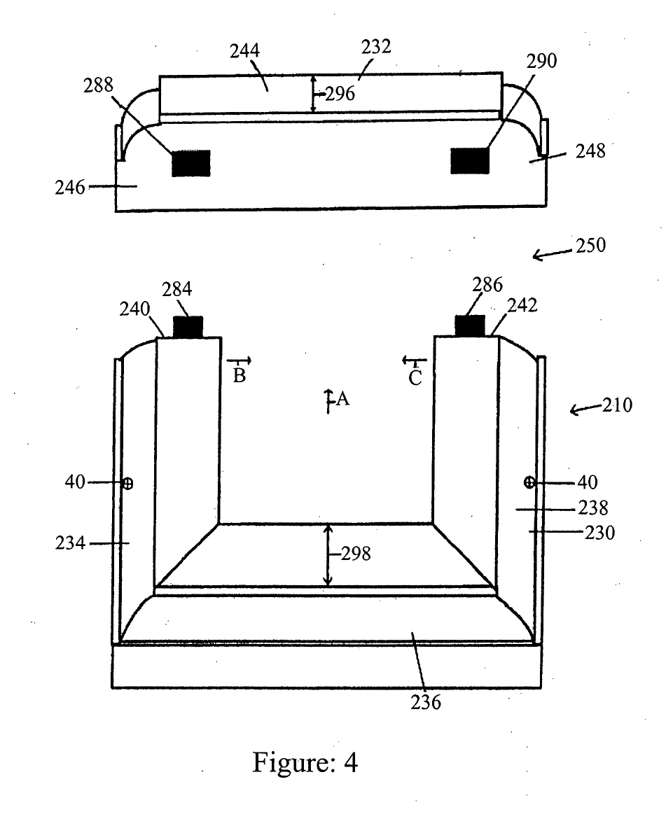

FIG. 4 illustrates a top view of an alternative downspout framing system 210 formed in accordance with an alternative embodiment. The downspout framing system 210 includes a first skirt member 230 and a second skirt member 232. The first skirt member 230 includes a first leg 234, a second leg 236, and a third leg 238. The first skirt member is substantially U-shaped, wherein the first leg 234 is perpendicular to the second leg 236, the second leg 236 is perpendicular to the third leg 238, and the third leg 238 is parallel to and spaced apart from the first leg 234. In the exemplary embodiment, the first and third legs 234 and 238 have a substantially equal length. The second leg 236 may have the same length or a different length than each of the first and third legs 234 and 238. Each of the first, second and third legs 234, 236 and 238 are coupled together using known manufacturing or assembly techniques.

In the exemplary embodiment, the first skirt member 230 includes two exposed ends 240 and 242. The first exposed end 240 is on the first leg 234 opposite the second leg 236. The second exposed end 242 is on the third leg 238 opposite the second leg 236. Optionally, the exposed ends 240 and 242 may extend along a common plane perpendicular to the first and third legs 234 and 238 and substantially parallel to the second leg 236. Alternatively, the exposed ends 240 and 242 may be angled with respect to a longitudinal direction of the legs 234 and 238. In the illustrated embodiment, the exposed ends 240 and 242 face outward in the longitudinal direction of the legs 234 and 238, such as in the direction of arrow A. Alternatively, the exposed ends 240 and 242 may face inwardly toward one another, such as in the directions of arrows B and C, respectively.

The second skirt member 232 includes a fourth leg 244 extending linearly. The fourth leg 244 extends between a third exposed end 246 and a fourth exposed end 248. In the illustrated embodiment, the third and fourth exposed ends 246 and 248 face inward, in a direction transverse to a longitudinal direction of the fourth leg 244, such as in a direction opposite arrow A. Alternatively, the third and fourth exposed ends 246 and 248 face outward, in a direction along the longitudinal direction of the fourth leg 244, such as in directions opposite arrows B and C, respectively. In either embodiment, the exposed ends 246 and 248 face, and are oriented to engage, the exposed ends 240 and 242 of the first and third legs 234 and 238, respectively. A fastening system 250 is used to couple the first and second skirt members 230 and 232 together.

The fastening system 250 includes a first fastening element 284, a second fastening element 286, a third fastening element 288, and a fourth fastening element 290. However, more or less fastening elements may be utilized in the fastening system 250. In the exemplary embodiment, the fastening elements 284, 286, 288 and 290 are coupled to the exposed ends 240, 242, 246 and 248, respectively. The first and third fastening elements 284 and 288 cooperate to couple the first and fourth legs 234 and 244 to one another. In the illustrated embodiment, the first fastening element 284 represents a vinyl male extension protruding outward from the first exposed end 240 and the third fastening element 288 represents a female recessed cut-out along the third exposed end 246. In the illustrated embodiment, the male extension 284 and the female recessed cut-out 288 are formed of the same material as the first leg 234 and the fourth leg 244 and may be molded or manufactured at the same time as legs 234 and 244. The first fastening element 284 is sized and shaped to substantially fill the cut-out 288. Optionally, the first fastening element 284 and the cut-out 288 may be rectangular. Alternatively, the first fastening element 284 and the cut-out 288 may be any other shape, such as square, circular, oval, triangular, or irregularly shaped. When placed together, the fastening elements 284 and 288 interact with one another to couple the first and fourth legs 234 and 244 to one another. In alternative embodiments, the first and third fastening elements 284 and 288 may be other types of fasteners, such as, but not limited to, hook and loop fasteners, a screw bore and a screw, a latch system, a hook and catch system, a buckle and strap system, a keyed jigsaw opening and receiving element, a rail or channel and receiving arm system, dowels or pins and corresponding openings, magnetic plates, and the like.

Similarly, the second and fourth fastening elements 286 and 290 cooperate to couple the third and fourth legs 238 and 244 to one another. In the illustrated embodiment, the fourth fastening element 290 represents a female recessed cut-out along the fourth exposed end 248 and the second fastening element 286 represents a vinyl male extension protruding outward from the second exposed end 242. In the illustrated embodiment, the male extension 286 and the female recessed cut-out 290 are formed of the same material as the third leg 238 and the fourth leg 244 and may be molded or manufactured at the same time as legs 238 and 244. The second fastening element 286 is sized and shaped to substantially fill the cut-out 290. Optionally, the second fastening element 286 and the cut-out 290 may be rectangular. Alternatively, the second fastening element 286 and the cut-out 290 may be any other shape, such as square, circular, oval, triangular, or irregularly shaped. When placed together, the fastening elements 286 and 290 interact with one another to couple the third and fourth legs 238 and 244 to one another. In alternative embodiments, the second and fourth fastening elements 286 and 290 may be other types of fasteners, such as, but not limited to, hook and loop fasteners, a screw bore and a screw, a latch system, a hook and catch system, a buckle and strap system, a keyed jigsaw opening and receiving element, a rail or channel and receiving arm system, dowels or pins and corresponding openings, magnetic plates, and the like.

During assembly, the second skirt member 232 is placed adjacent the downspout 12 along a first side wall of the downspout 12. In an exemplary embodiment, the second skirt member 232 is placed between the downspout 12 and the siding 16 of the building 18 (shown in FIG. 1). Optionally, because the amount of space between the downspout 12 and the building 18 may be limited, a thickness 296 of the second skirt member 232 may be reduced as compared to a thickness 298 of the first skirt member 230. Once the second skirt member 232 is positioned, the first skirt member 230 is brought into a pre-mating position, such as the position illustrated in FIG. 4. In the pre-mating position, the fastening elements 284 and 288 are aligned and the fastening elements 286 and 290 are aligned. The first and/or second skirt members 230 and/or 232 are moved toward one another to an assembled position, wherein the first fastening element 284 is received within the cut-out 288 and the first and third fastening elements 284 and 288 securely hold the first and third exposed ends 240 and 246 together. Similarly, in the assembled position, the second fastening element 286 is received within the cut-out 290 and the second and fourth fastening elements 286 and 290 securely hold the second and fourth exposed ends 242 and 248 together. Once assembled, the first and second skirt members 230 and 232 surround the perimeter of the downspout 12.

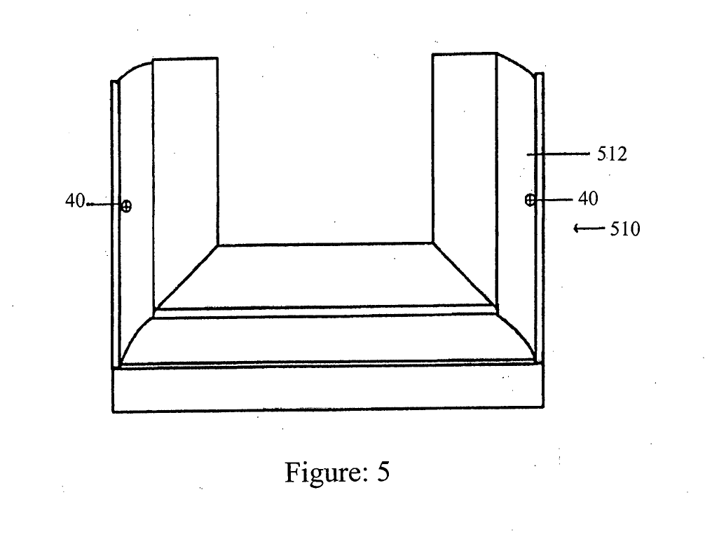

FIG. 5 illustrates a top view of an alternative downspout framing system 510 formed in accordance with an alternative embodiment. The framing system 510 is substantially similar to the framing system 210, however the framing system 510 includes a single skirt member 512. In the illustrated embodiment, the skirt member 512 is U-shaped and is configured to surround three sides of a downspout (not shown). The skirt member 512 may be used in situations where the downspout is in close proximity, or even touching, the building or structure (not shown) such that a second skirt member, such as the second skirt member 232 shown in FIG. 4, would be unable to be positioned between the downspout and the building. The skirt member 512 may be secured in place using fastener bores 40 that secure the skirt member 512 to the decking surface (not shown). Alternatively, fasteners may be used to secure the skirt member 512 to the downspout, such as by using magnets, adhesive, a fastener such as a screw or nail, and the like.

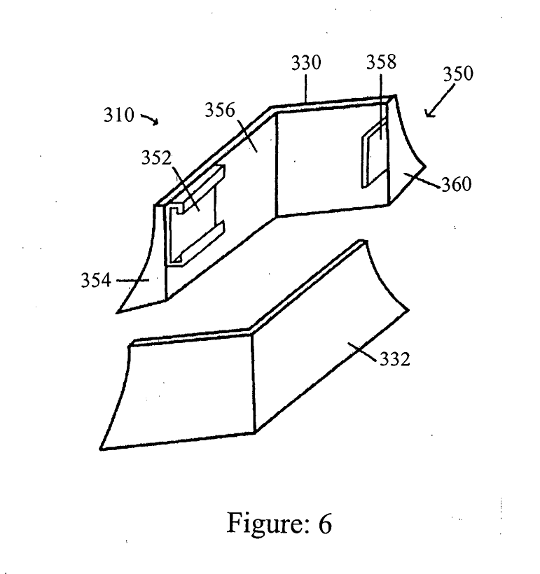

FIG. 6 illustrates a perspective view of another alternative downspout framing system 310 formed in accordance with an alternative embodiment. The downspout framing system 310 includes a first skirt member 330 and a second skirt member 332. A fastening system 350 is used to couple the first and second skirt members 330 and 332 to one another. The fastening system 350 includes a rail member 352 extending from a first end 354 of the first skirt member 330 along the inner surface 356 thereof and an arm 358 extending perpendicularly outward from a second end 360 of the first skirt member 330. Similarly, the second skirt member 332 includes a similar rail member (not shown) and a similar arm (not shown). The rail member of the second skirt member 332 receives the arm 358 of the first skirt member 330 therein. The rail member 352 receives the arm of the second skirt member 332 therein. Optionally, the arms are frictionally engaged by the rail members to securely couple the first and second skirt members 330 and 332. Optionally, the rail members may extend outward from the inner surface 356, as illustrated in FIG. 6. Alternatively, the rail members may be received or recessed within the body of the skirt members 330 and 332 such that the inner surfaces 356 may engage the side walls of the downspout 12. In one alternative embodiment, the rail member 352 may extend the length of the leg of the skirt member 330 to provide a uniform reveal when viewed from the top and such that the spacing between the skirt member 330 and the downspout is uniform along the length of the leg.

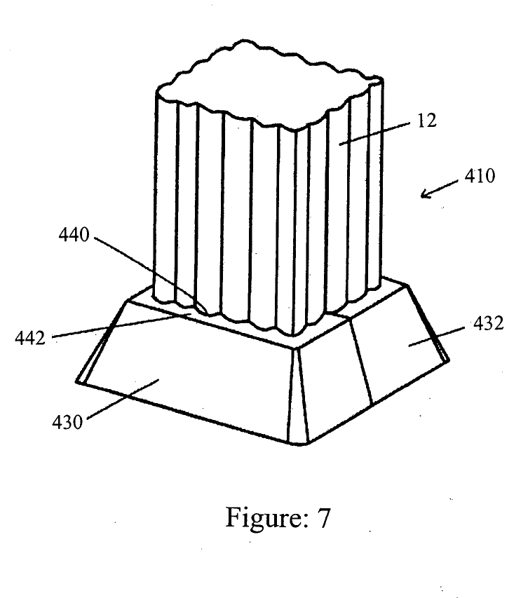

FIG. 7 illustrates a perspective view of yet another alternative downspout framing system 410 formed in accordance with an alternative embodiment and illustrated in an assembled state. The downspout framing system 410 includes a first skirt member 430 and a second skirt member 432. In the illustrated embodiment, the first and second skirt members 430 and 432 are each U-shaped members such that the first and second skirt members 430 and 432 each engage three side walls of the downspout 12. The skirt members 430 and 432 interface with one another approximately at the mid-point of the two opposed side walls of the downspout 12. Optionally, an edge 440 between a top surface 442 and an inner surface (not shown) of the skirt members 430 and 432 is non-linear. Additionally, the inner surface of the skirt members 430 and 432 is non-planar and follows the non-linear edge 440. The non-linear edge 440 and the non-planar inner surface provide a rippling along the inner surface. The rippling is provided to interface with the contoured side walls of the downspout. The rippling and the contoured side walls have a similar pattern such that the skirt members 430 and 432 may engage the side walls of the downspout 12. In one embodiment, a fastening system, such as the fastening systems described above, may be used to couple the first and second skirt members 430 and 432 to one another. Alternatively, and in the illustrated embodiment, the fastening system may include features and or characteristics of the skirt members 430 and 432 for attaching to the downspout 12. For example, the first and second skirt members 430 and 432 may be resiliently held against the downspout 12, such as by a friction-fit or a tendency of the first and second skirt members 430 and 432 to spring-back against the downspout 12. Optionally, the first and second skirt members 430 and 432 may have an elastic characteristic which tends to force the exposed ends of the skirt member 430, and similarly the exposed ends of the skirt member 432, generally toward one another, such that the ends pinch the downspout 12, thus holding the skirt members 430 and 432 in place with respect to the downspout 12. When the skirt members 430 and 432 are held in place on the downspout 12, the exposed ends of each skirt member 430 and 432 may be engaged with one another. In one exemplary embodiment, the rippling, or non-linear edge 440 engages the corresponding contoured side walls of the downspout 12 to hold the first and second skirt members 430 and 432 in position with respect to the downspout 12.

A downspout framing system 10 is thus provided that can be installed in a quick and reliable manner. The system includes two skirt members 30 and 32 that are coupled together, such as by using a fastening system 50. Other alternative embodiments may include more than two members, such as four members that completely surround the downspout 12. The skirt members 30 and 32 are placed upon a decking surface 14 (e.g. deck railing or deck flooring) at the interface between the downspout 12 and the decking surface 14 to provide a finished look to the downspout 12 and/or the decking surface 14, and to provide stability to the downspout 12 within the opening. This prevents damage to the downspout 12. Moreover, the skirt members 30 and 32 may be secured to the decking surface 14 to provide added stability. The skirt members 30 and 32 may be assembled by an individual without the need for special tooling, such as saws and measuring devices, or special carpentry skills. As such, the downspout framing system 10 is relatively inexpensive and easy to install. The skirt members 30 and 32 may come in a variety of sizes and shapes for use with different downspouts 12. Moreover, the downspout framing system 10 is weather resistant, may be made in any of a variety of materials and colors to match the type of decking material or downspout material used.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A downspout skirt comprising:
a first skirt member comprising first and second exposed ends, the first skirt member comprising an inner surface configured to engage a side wall of a downspout;
a second skirt member comprising third and fourth exposed ends, the second skirt member comprising an inner surface configured to engage a different side wall of the downspout, whereby the first and second skirt members are removably coupled to the downspout.

2. The downspout skirt of claim 1, wherein the first skirt member further comprises a bottom surface being substantially perpendicular to the inner surface of the first skirt member, and wherein the second skirt member further comprises a bottom surface being substantially perpendicular to the inner surface of the second skirt member, the bottom surfaces being substantially parallel to one another and configured to engage a supporting structure.

3. The downspout skirt of claim 1., wherein the first skirt member includes a first leg and a second leg, the first and second legs are substantially perpendicular to one another, the inner surface along the first leg is configured to engage a first side wall of a downspout, the inner surface along the second leg is configured to engage a second side wall of the downspout, the first side wall being substantially perpendicular to the second side wall.

4. The downspout skirt of claim 3, wherein the first skirt member includes a third leg, the third leg being substantially parallel to the first leg and substantially perpendicular to the second leg, the inner surface along the third leg configured to engage a third side wall of the downspout.

5. The downspout skirt of claim 1, wherein the first skirt member includes a first leg and a second leg having an L-shaped configuration, and wherein the second skirt member includes a third leg and a fourth leg having an L-shaped configuration, the first and second skirt members being coupled to one another and forming an opening configured to surround a perimeter of a downspout.

6. The downspout skirt of claim 1, further comprising a fastening system, wherein the fastening system comprises one of extensions and recessions, magnets, hook and pile fasteners, pins, dowels, rails, openings and screws.

7. The downspout skirt of claim 1, wherein the first and second skirt members are configured to be resiliently coupled to the downspout.

8. The downspout skirt of claim 1, wherein the first and second skirt members are coupled at the exposed ends thereof, and wherein the exposed ends are mitered.

9. A downspout framing system for framing side walls of a downspout proximate a downspout portion extending through a decking surface, said system comprising:
a first skirt member comprising first and second exposed ends, the first skirt member comprising an inner surface configured to engage a side wall of the downspout, and the first skirt member having a base configured to rest upon the decking surface proximate the downspout;
a second skirt member comprising third and fourth exposed ends, the second skirt member comprising an inner surface configured to engage a different side wall of the downspout, and the second skirt member having a base configured to rest upon the decking surface proximate the downspout, whereby the first and second skirt members are removably coupled to the downspout.

10. The system of claim 9, wherein the first skirt member includes a first leg and a second leg, the first and second legs are substantially perpendicular to one another, the inner surface along the first leg is configured to engage a first side wall of a downspout, the inner surface along the second leg is configured to engage a second side wall of the downspout, the first side wall being substantially perpendicular to the second side wall.

11. The system of claim 10, wherein the first skirt member includes a third leg, the third leg being substantially parallel to the first leg and substantially perpendicular to the second leg, the inner surface along the third leg configured to engage a third side wall of the downspout.

12. The system of claim 9, wherein the first and second skirt members are configured to be resiliently coupled to the downspout.

13. The system of claim 9, wherein the first skirt member includes a first leg and a second leg having an L-shaped configuration, and wherein the second skirt member includes a third leg and a fourth leg having an L-shaped configuration, the first and second skirt members being coupled to one another and forming an opening configured to surround a perimeter of a downspout.

14. The system of claim 9, further comprising a fastening system, wherein the fastening system includes a male extension positioned along the first exposed end of the first skirt member and the fastening system includes a female recessed cut-out positioned along the third exposed end of the second skirt member, the male extension interacting with the female cut-out during mating of the first and second skirt members to removably couple the first and second skirt members.

15. The system of claim 9, further comprising a fastening system, wherein the fastening system includes a coupling sleeve positioned along the inner surface of the first skirt member proximate the first exposed end and the fastening system includes a coupling arm extending from the third exposed end of the second skirt member, the coupling arm received within the coupling sleeve during mating of the first and second skirt members to removably couple the first and second skirt members.

16. A downspout framing system for framing side walls of a downspout proximate a downspout portion extending through a decking surface, said system comprising:
a first skirt member comprising first and second exposed ends, the first skirt member comprising an inner surface configured to engage a side wall of the downspout, and the first skirt member having a base configured to rest upon the decking surface proximate the downspout;
a second skirt member comprising third and fourth exposed ends, the second skirt member comprising an inner surface configured to engage a different side wall of the downspout, and the second skirt member having a base configured to rest upon the decking surface proximate the downspout; and
a fastening system for removably coupling the first and second exposed ends of the first skirt member to the third and fourth exposed ends of the second skirt member.

17. The system of claim 16, wherein the fastening system includes a male extension positioned along the first exposed end of the first skirt member and the fastening system includes a female recessed cut-out positioned along the third exposed end of the second skirt member, the male extension interacting with the female cut-out during mating of the first and second skirt members to removably couple the first and second skirt members.

18. The system of claim 16, wherein the fastening system includes a coupling sleeve positioned along the inner surface of the first skirt member proximate the first exposed end and the fastening system includes a coupling arm extending from the third exposed end of the second skirt member, the coupling arm received within the coupling sleeve during mating of the first and second skirt members to removably couple the first and second skirt members.

19. The system of claim 16, wherein the fastening system includes a first magnetic element positioned along the first exposed end of the first skirt member and the fastening system includes a second magnetic element positioned along the third exposed end of the second skirt member, the first and second magnetic elements interacting with one another during mating of the first and second skirt members to removably couple the first and second skirt members, wherein at least one of the first and second magnetic elements create a magnetic field.

20. The system of claim 16, wherein the downspout includes four sides, the first skirt member including at least two legs, each of the legs abutting against a different one of the sides of the downspout, the second skirt member including at least one leg abutting against a different side of the downspout than the legs of the first skirt member.
